(19) United States
(12) Patent Application Publication
(10) Pub. No.: US 2007/0022961 A1
(43) Pub. Date: Feb. 1, 2007

(54) Colostrum collection system

(76) Inventor: Raymond C. Wheeler, Ellendale, MN (US)

Correspondence Address: NEUSTEL LAW OFFICES, LTD., 2534 SOUTH UNIVERSITY DRIVE, SUITE 4, FARGO, ND, 58103, US

(21) Appl. No.: 11/194,922

(22) Filed: Aug. 1, 2005

(51) Int. Cl. A01J 1/00

(52) U.S. Cl. 119/14.01

(57) ABSTRACT

A colostrum collection system for efficiently collecting colostrum from an animal. The colostrum collection system includes a vacuum pump, a receiver tube fluidly connected to the vacuum pump, and a container removably attached to the receiver tube for collecting the colostrum. The receiver tube has an upper opening that receives the teat of an udder in a sealed manner. The vacuum pump creates a vacuum within the receiver tube thereby drawing the colostrum from udder of the animal. The colostrum passes through the receiver tube and enters the container for storage during the collection of additional colostrum. When the colostrum is fully collected, the container is removed from the receiver tube for storage or immediate feeding to a newborn.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to milking devices and more specifically it relates to a colostrum collection system for efficiently collecting colostrum from an animal.

Colostrum (a.k.a. foremilk) is the first milk secreted by an animal at the time of parturition. Colostrum differs from the milk secreted later since it contains more lactalbumin and lactoprotein, and also is rich in antibodies that confer passive immunity to the newborn. The collection of colostrum for a newborn can be very important for preventing infection and sickness within the newborn.

2. Description of the Related Art

Any discussion of the prior art throughout the specification should in no way be considered as an admission that such prior art is widely known or forms part of common general knowledge in the field.

Milking devices and systems have been in use for years ranging from hand milking to breast pumps to mechanized assembly milking for dairy cows. The problem with hand milking methods is that they are inefficient and can result in contamination of the milk. The problem with breast pumps is that they are designed for human breasts and are not suitable for usage upon the teats of animals (e.g. horses, cattle, goats and sheep). The problem with mechanized assembly milking systems is that they are designed for large scale operation and are not suitable for single animal milking for the purpose of collecting colostrum.

While these milking devices may be suitable for the particular purpose to which they address, they are not as suitable for efficiently collecting colostrum from an animal. Conventional milking devices are designed for collecting the milk on a larger volume that comes after the colostrum and are not designed for efficiently collecting the colostrum for a newborn.

In these respects, the colostrum collection system according to the present invention substantially departs from the conventional concepts and designs of the prior art, and in so doing provides an apparatus primarily developed for the purpose of efficiently collecting colostrum from an animal.

### BRIEF SUMMARY OF THE INVENTION

In view of the foregoing disadvantages inherent in the known types of milking devices now present in the prior art, the present invention provides a new colostrum collection system construction wherein the same can be utilized for efficiently collecting colostrum from an animal.

The general purpose of the present invention, which will be described subsequently in greater detail, is to provide a new colostrum collection system that has many of the advantages of the milking devices mentioned heretofore and many novel features that result in a new colostrum collection system which is not anticipated, rendered obvious, suggested, or even implied by any of the prior art milking devices, either alone or in any combination thereof.

To attain this, the present invention generally comprises a vacuum pump, a receiver tube fluidly connected to the vacuum pump, and a container removably attached to the receiver tube for collecting the colostrum. The receiver tube has an upper opening that receives the teat of an udder in a sealed manner. The vacuum pump creates a vacuum within the receiver tube thereby drawing the colostrum from udder of the animal. The colostrum passes through the receiver tube and enters the container for storage during the collection of additional colostrum. When the colostrum is fully collected, the container is removed from the receiver tube for storage or immediate feeding to a newborn.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a colostrum collection system that will overcome the shortcomings of the prior art devices.

A second object is to provide a colostrum collection system for efficiently collecting colostrum from an animal.

Another object is to provide a colostrum collection system that may be utilized on various types of animals such as but not limited to horses, cattle, goats and sheep.

An additional object is to provide a colostrum collection system that may be utilized for collecting colostrum that may be stored or utilized for a different newborn.

A further object is to provide a colostrum collection system that can be held and operated with a single hand.

Another object is to provide a colostrum collection system that efficiently collects the colostrum into a sanitary bottle.

Another object is to provide a colostrum collection system that allows for the collection of colostrum for animals that are difficult to milk.

Another object is to provide a colostrum collection system that is non-invasive to the animal.

Another object is to provide a colostrum collection system that allows for immediate colostrum being fed directly to a newborn animal to provide it with the antibodies needed to prevent disease and infection.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an exploded upper perspective view of the present invention.

FIG. 3 is an exploded side view of the receiver tube above the container.

FIG. 4 is an exploded side view of the vacuum pump and the receiver tube connected to the container.

FIG. 5 is a side view of the vacuum pump connected to the receiver tube.

FIG. 6 is an exploded side view of the receiver tube positioned below a teat of an udder.

FIG. 7 is a side view of the receiver tube positioned about the teat of the udder.

FIG. 8 is a side view of the receiver tube sealed about the teat with colostrum being drawn into the receiver tube and container from the vacuum created by the vacuum pump.

FIG. 9a is a side view of the receiver tube.

FIG. 9b is a side view of the receiver tube having a wider upper end.

### DETAILED DESCRIPTION OF THE INVENTION

A. Overview

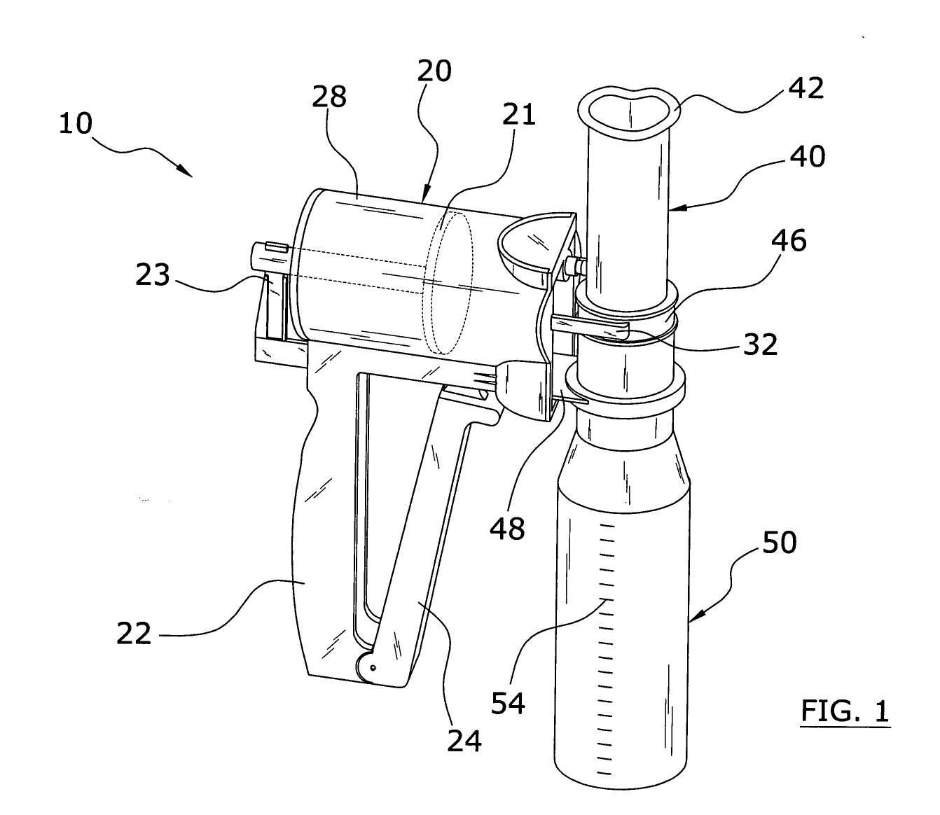

Turning now descriptively to the drawings, in which similar reference characters denote similar elements throughout the several views, FIGS. 1 through 9b illustrate a colostrum collection system 10, which comprises a vacuum pump 20, a receiver tube 40 fluidly connected to the vacuum pump 20, and a container 50 removably attached to the receiver tube 40 for collecting the colostrum. The receiver tube 40 has an upper opening that receives the teat 14 of an udder 12 in a sealed manner. The vacuum pump 20 creates a vacuum within the receiver tube 40 thereby drawing the colostrum from udder 12 of the animal. The colostrum passes through the receiver tube 40 and enters the container 50 for storage during the collection of additional colostrum. When the colostrum is fully collected, the container 50 is removed from the receiver tube 40 for storage or immediate feeding to a newborn.

B. Receiver Tube

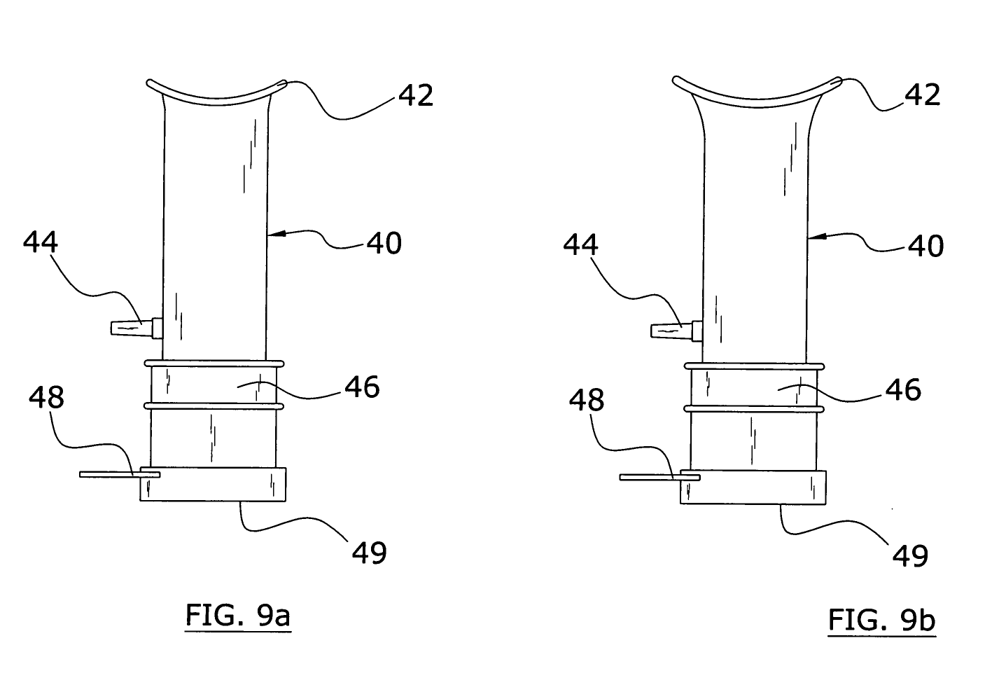

FIGS. 1 through 9b of the drawings illustrate an exemplary receiver tube 40 suitable for usage within the present invention. The receiver tube 40 includes an upper opening that is capable of sealably receiving a teat 14 of an udder 12 as illustrated in FIGS. 1, 2, 6 and 7 of the drawings. The upper opening preferably has a concave shape as illustrated in FIGS. 1 through 9b of the drawings. The upper opening may have various widths, sizes and curvatures as shown in FIGS. 9a and 9b of the drawings.

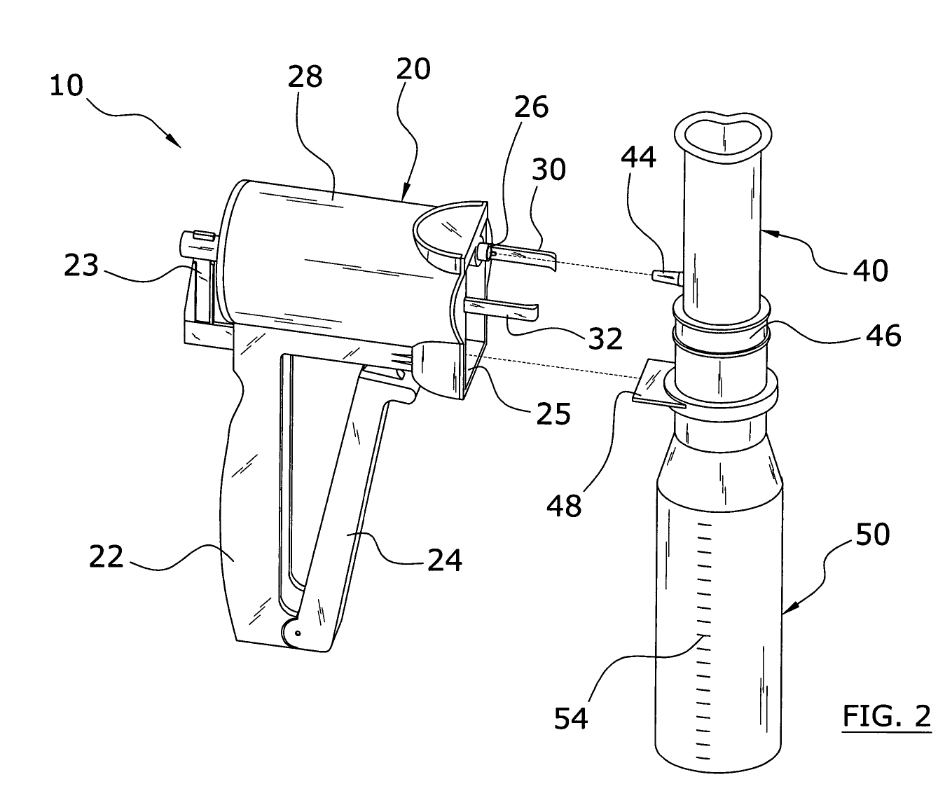

The receiver tube 40 preferably includes an upper seal 42 attached about the upper opening as best illustrated in FIGS. 1 and 2 of the drawings. The upper seal 42 is preferably comprised of a rubber material or other material capable of sealing against an udder 12 and teat 14 of an animal.

The receiver tube 40 includes a receiver connector 44 that is catchably received by the vacuum pump 20 as illustrated in FIGS. 1 through 9b of the drawings. The receiver connector 44 preferably includes a receiver groove 46 for receiving the first prong 30 and the second prong 32 that extend from the vacuum pump 20 as illustrated in FIGS. 9a through 9b of the drawings.

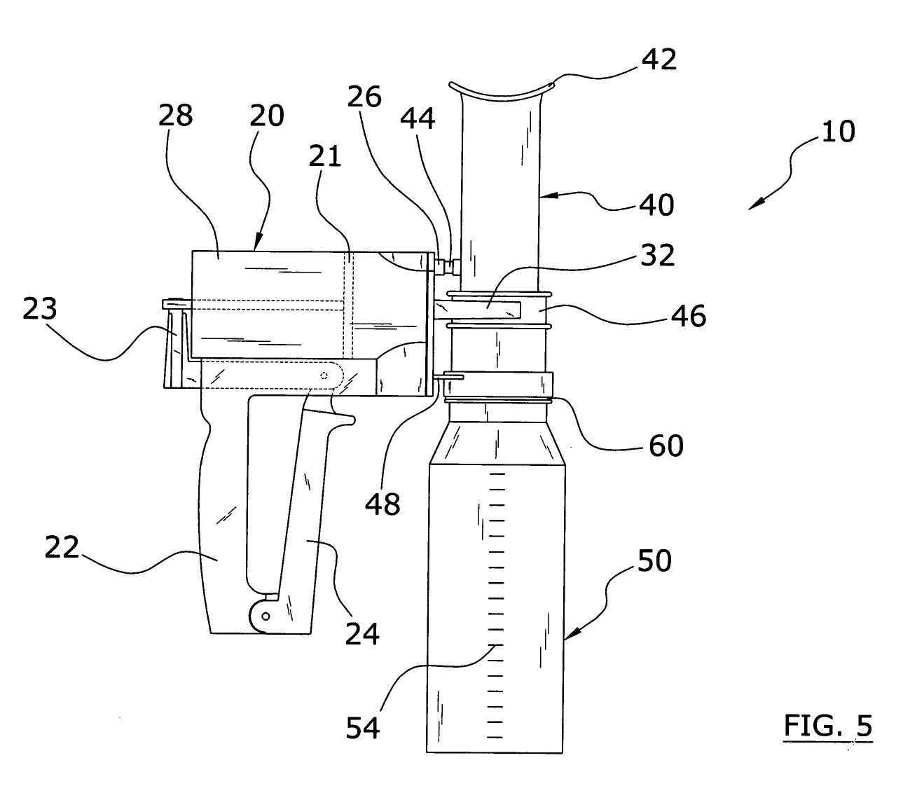

A threaded coupler 49 that is threadably attachable to a threaded end 52 of the container 50. The receiver tube 40 includes a tongue member 48 extending substantially transversely from the receiver tube 40 as shown in FIGS. 1 through 9b of the drawings. The vacuum pump 20 includes a front opening with a floor 25 that receives and supports the tongue member 48 as best illustrated in FIGS. 1 and 2 of the drawings. The weight of the receiver tube 40 and the container 50 with the colostrum is preferably substantially supported by the tongue member 48 resting upon the floor 25 of the vacuum pump 20 as illustrated in FIGS. 1 and 5 of the drawings.

C. Vacuum Pump

The vacuum pump 20 is fluidly connected to the receiver tube 40 for creating a vacuum within the receiver tube 40. The vacuum pump 20 may be comprised of a motorized pump structure, a manual pump structure, or any other well known pump structure capable of generating a vacuum.

In the preferred embodiment, the vacuum pump 20 includes a housing 28 having an interior portion and a plunger 21 movably positioned within the interior portion for creating a vacuum. A vacuum connector 26 is fluidly connected to the housing 28 for removably coupling to a receiver connector 44 extending from the receiver tube 40. The vacuum connector 26 fluidly connects to the receiver connector 44 for creating a vacuum within the receiver tube 40 for drawing the colostrum from the udder 12 through the teat 14 of the animal.

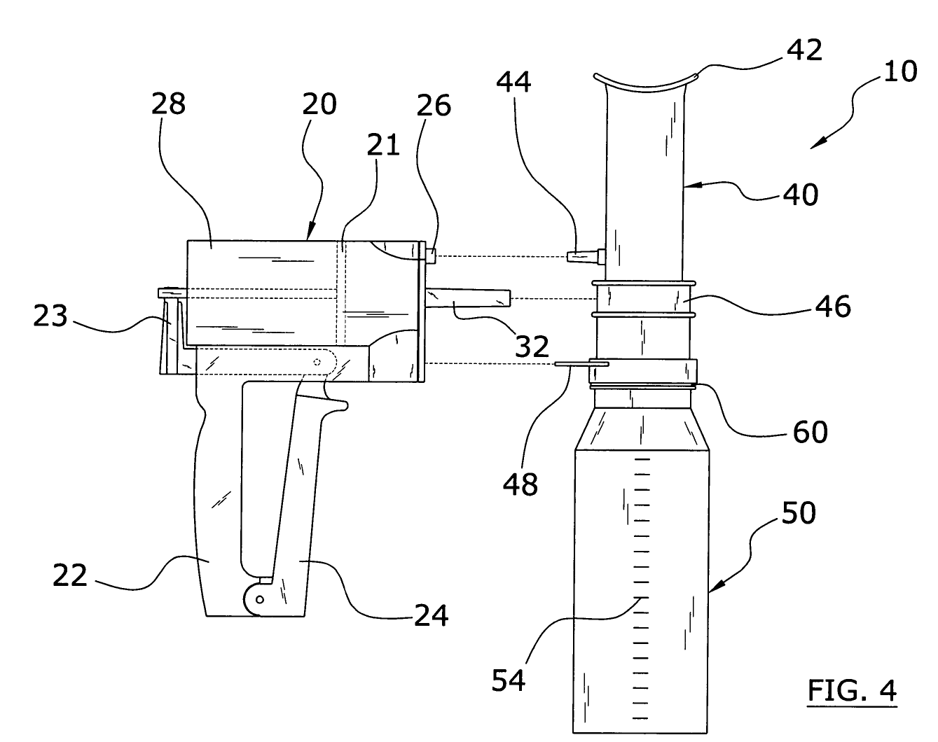

The vacuum pump 20 also preferably includes a handle 22 extending from the housing 28 and a lever 24 pivotally attached to the handle 22 as best illustrated in FIGS. 1, 2 and 4 of the drawings. A pump connector 23 is attached between the lever 24 and the plunger 21 as further shown in FIGS. 1, 2 and 4 of the drawings. The pump connector 23 is comprised of a U-shaped structure wherein one prong of the pump connector 23 is slidably positioned within the handle 22 and wherein the other prong of the pump connector 23 extends through a rear opening within the housing 28 to engage the plunger 21 as best illustrated in FIGS. 4 and 5 of the drawings. The movement of the lever 24 causes movement of the plunger 21 within the housing 28 to create a vacuum. A compressing spring or other biasing means may be attached to the housing 28 and the pump connector 23 for providing a return force to the plunger 21 and lever 24.

The vacuum pump 20 preferably includes a first prong 30 and a second prong 32 for catchably receiving the receiver connector 44 as illustrated in FIGS. 1 and 2 of the drawings. The first prong 30 and the second prong 32 each preferably have a distally hooked end.

D. Container 50

FIGS. 1 through 9b of the drawings illustrate an exemplary container 50 that is removably attachable to the lower end of the receiver tube 40 for collecting colostrum drawn through the teat 14 of the udder 12. The container 50 may be comprised of various other structures other than illustrated in the drawings. The container 50 has an upper threaded end 52 that is threadably connectable to the threaded coupler 49 of the receiver tube 40 and that may also be threadably connected to a feeding nipple for immediate feeding to a newborn animal or a threaded cap for storage. The container 50 preferably includes a plurality of measurement indicia 54 for indicating the volume of colostrum collected within the container 50.

E. Operation of Invention

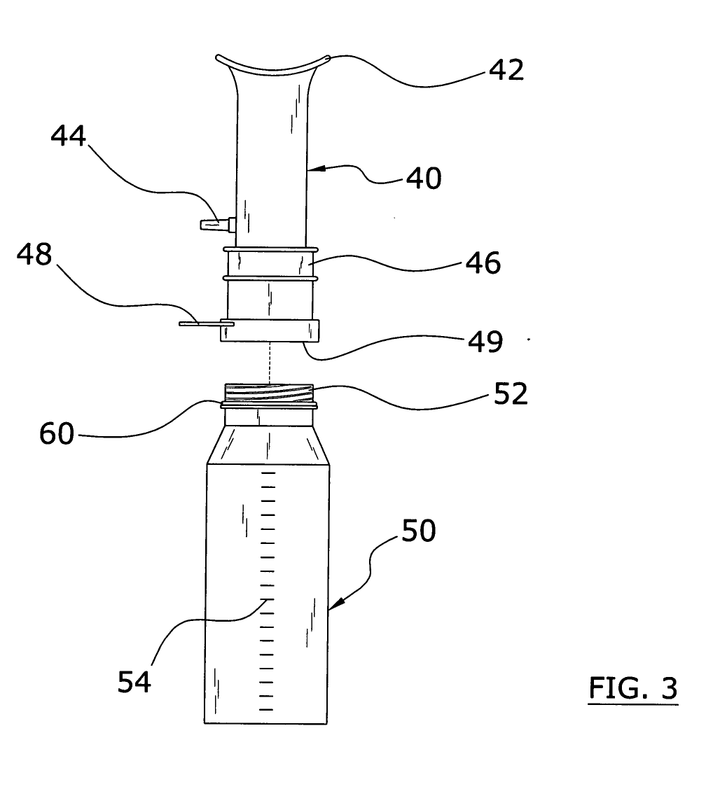

In use, the user first attaches the receiver tube 40 to a desired container 50 as shown in FIG. 3 of the drawings. After the receiver tube 40 is properly secured to the container 50, the user then attaches the receiver tube 40 to the vacuum pump 20 as illustrated in FIGS. 1, 2 and 4 of the drawings. In particular, the user aligns the vacuum connector 26 of the vacuum pump 20 with the receiver connector 44 so that they are fluidly connected to one another when the receiver tube 40 is properly attached to the vacuum pump 20. The user positions the receiver connector 44 such that the prongs 30, 32 extending from the vacuum pump 20 catchably extend about the receiver groove 46 within the receiver connector 44 as shown in FIG. 1 of the drawings. In addition, the receiver connector 44 is fluidly connected to the vacuum connector 26 as shown in FIGS. 1 and 5 of the drawings.

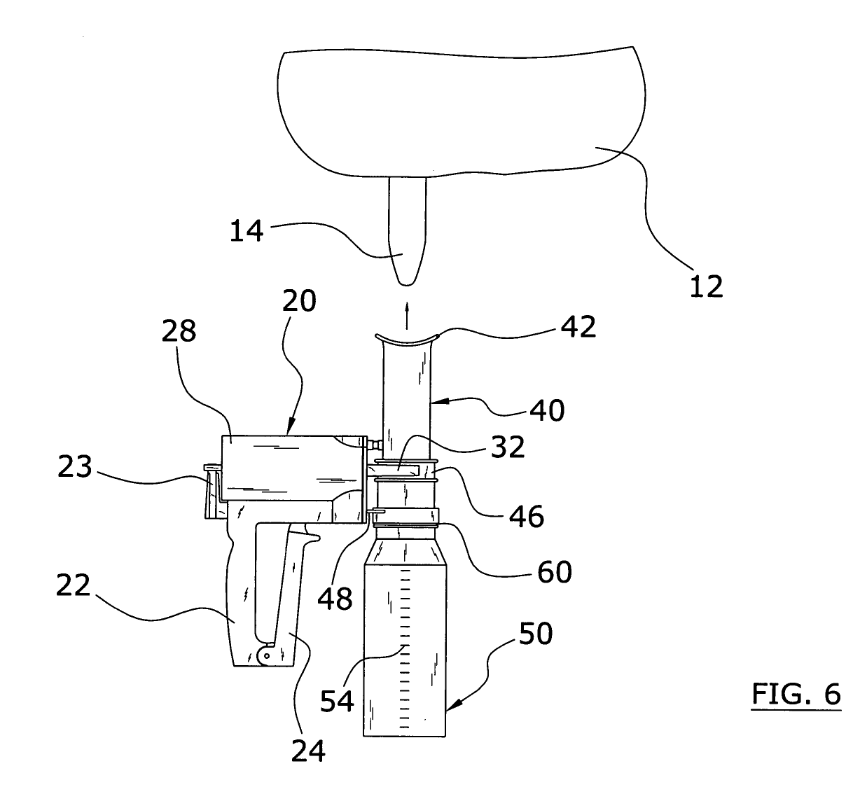

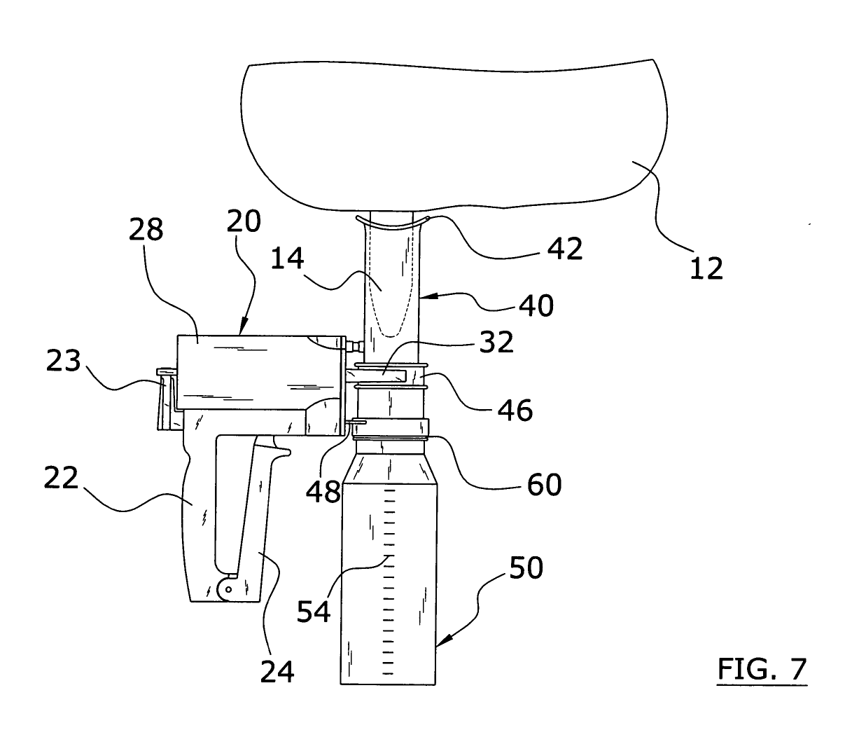

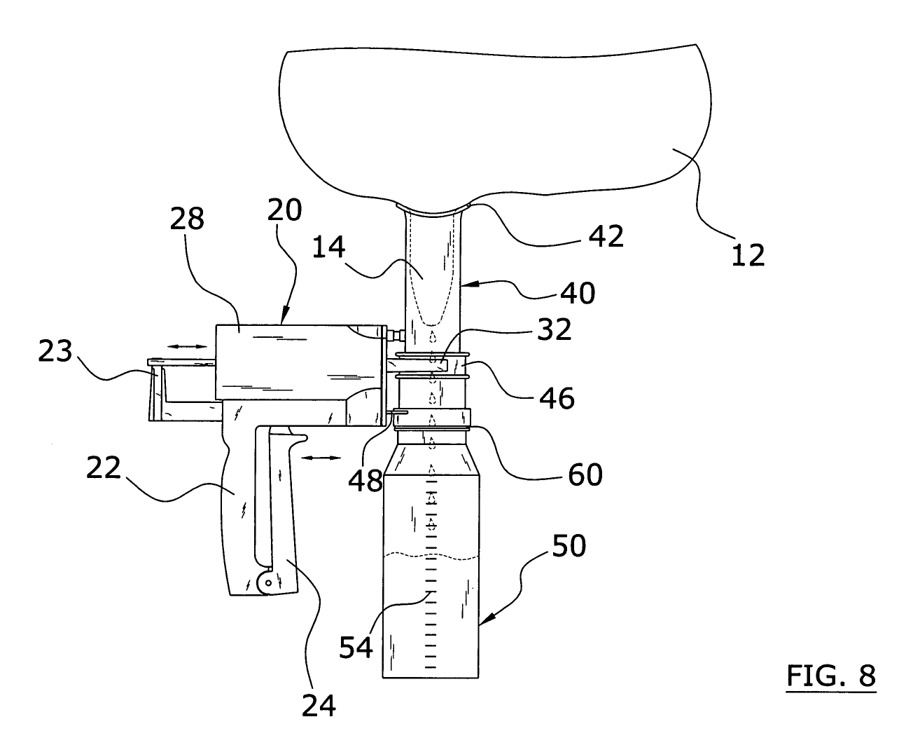

After the present invention is fully assembled, the user then positions the upper opening of the receiver tube 40 below the teat 14 of an animal where the colostrum is to be collected from as shown in FIG. 6 of the drawings. The user then elevates the receiver tube 40 upwardly so that the upper seal 42 is properly positioned adjacent the lower surface of the udder 12 and wherein the teat 14 is fully positioned within the interior of the receiver tube 40 as shown in FIG. 7 of the drawings. The user then pulls upon the lever 24 which causes the plunger 21 to be drawn from within the housing 28 thereby creating a vacuum within the interior of the housing 28, the receiver tube 40 and the container 50 as shown in FIG. 8 of the drawings. As the vacuum increases, the colostrum within the udder 12 is drawn through and released through the teat 14 as further shown in FIG. 8 of the drawings. The colostrum leaves the teat 14 and passes through the receive tube into the container 50 as shown in FIG. 8 of the drawings. If the colostrum drawn through the receiver tube 40 decreases in flow, the user may release the lever 24 and then pull again upon the lever 24 to increase the vacuum pressure.

After the desired volume of colostrum is collected within the container 50, the user then releases the lever 24 and pushes the receiver tube 40 in a forward manner to break the seal of the upper seal 42 with the udder 12 and teat 14. Once the seal is broken, the user is able to remove the receiver tube 40 from the teat 14. The container 50 can then be removed from the receiver tube 40 as shown in FIG. 3 of the drawings (with the receiver tube 40 attached or unattached to the vacuum pump 20). The threaded end 52 of the container 50 may then receive a threaded cap for storage of the colostrum or a threaded nipple for immediately feeding the colostrum to a newborn animal. The colostrum within the container 50 may also be poured into a different container 50 for feeding or storage. After usage, the present invention is cleaned and may be repeatedly utilized.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A colostrum collection system, comprising:
a receiver tube including an upper opening that is capable of sealably receiving a teat of an udder;
a vacuum pump fluidly connected to said receiver tube for creating a vacuum within said receiver tube; and
a container removably attached to said receiver tube for collecting colostrum.

2. The colostrum collection system of claim 1, wherein said receiver tube includes an upper seal attached about said upper opening.

3. The colostrum collection system of claim 2, wherein said upper seal is comprised of a rubber material.

4. The colostrum collection system of claim 1, wherein said upper opening has a concave shape.

5. The colostrum collection system of claim 1, wherein said receiver tube includes a receiver connector that is catchably received by said vacuum pump.

6. The colostrum collection system of claim 5, wherein said vacuum pump includes a first prong and a second prong catchably receiving said receiver connector.

7. The colostrum collection system of claim 6, wherein said first prong and said second prong each have a distally hooked end.

8. The colostrum collection system of claim 7, wherein said receiver connector includes a receiver groove for receiving said first prong and said second prong.

9. The colostrum collection system of claim 1, wherein said receiver tube includes a threaded coupler that is threadably attachable to a threaded end of said container.

10. The colostrum collection system of claim 1, wherein said container includes a plurality of measurement indicia.

11. The colostrum collection system of claim 1, wherein said receiver tube includes a tongue member extending substantially transversely from said receiver tube, and wherein said vacuum pump includes a floor that receives and supports said tongue member.

12. The colostrum collection system of claim 1, wherein said vacuum pump includes:
a housing having an interior portion;
a plunger movably positioned within said interior portion;
a vacuum connector fluidly connected to said housing for removably coupling to a receiver connector extending from said receiver tube;
a handle extending from said housing;
a lever pivotally attached to said handle; and
a pump connector attached between said lever and said plunger, wherein movement of said lever causes movement of said plunger within said housing to create a vacuum.
